(19) United States
(12) Patent Application Publication
(10) Pub. No.: US 2025/0178865 A1
(43) Pub. Date: Jun. 5, 2025

(54) SYSTEM AND METHOD FOR DETECTING BRAKE FAILURE

(71) Applicant: KONE CORPORATION, Helsinki (FI)

(72) Inventors: Matti Mustonen, Helsinki (FI); Mari Zakrzewski, Helsinki (FI); Juuso Meriläinen, Helsinki (FI); Olli Mali, Helsinki (FI); Ville Leppänen, Helsinki (FI); Jaakko Huhtala, Helsinki (FI); Juho Lankinen, Helsinki (FI)

(73) Assignee: KONE CORPORATION, Helsinki (FI)

(21) Appl. No.: 19/046,945

(22) Filed: Feb. 6, 2025

Related U.S. Application Data
(63) Continuation of application No. PCT/EP2022/074084, filed on Aug. 30, 2022.

(51) Int. Cl. B66B 5/00; B66B 5/18

(52) U.S. Cl. CPC B66B 5/0031; B66B 5/0025; B66B 5/18

(57) ABSTRACT

An elevator system for elevator brake failure detecting comprises: an elevator comprising a car; a hoisting machinery for driving the car in an elevator shaft between landing floors; and at least one mechanical brake for braking movement of the car and/or holding the car standstill; and the elevator system further comprises at least one sensor operable to obtain movement data of the car. The elevator system is configured to detect a change in the condition of said at least one mechanical brake based on said movement data obtained by the at least one sensor during normal operation. A method for elevator brake failure detecting in an elevator system.

### FIELD OF THE INVENTION

The invention relates to elevator brake failure detecting. The elevator is preferably an elevator for transporting passengers and/or goods.

### BACKGROUND OF THE INVENTION

Elevators have mechanical hoisting machinery brakes as safety devices to apply braking force to a traction sheave or a rotating axis of an elevator hoisting machine, to brake movement of the hoisting machine and therefore the elevator car. There are normally two separate brakes. They can be shoe brakes or disc brakes, for example, and have brake pads adapted to engage against a braking surface in the rotating part of the elevator hoisting machine. It is possible that in old elevators there is only one such hoisting machinery brake.

Hoisting machinery brake has a stationary frame and an armature movably supported on the frame, for example, by means of a sliding axle that protrudes through the frame. The frame may contain an electromagnet to produce an attraction force between the frame and the armature. Further, an energy storage, such as a compression spring may be disposed between the frame and the armature. A brake pad may be attached to the armature. The brake is opened by supplying electrical current to the electromagnet and closed by means of the energy storage upon interrupting of the current supply. Instead of an electromagnet other kind of actuators, such as hydraulic actuators may be used as well.

Brakes must be dimensioned to stop and hold an elevator car standstill in the elevator shaft. Additionally, they may be used in rescue situations and in emergency braking situations to stop elevator car if an operational fault occurs, like an overspeed situation of the elevator car. Further, they may be used to protect elevator passengers from unintended car movement at the landing and to provide safe operating environment for the servicemen inside the elevator shaft. Thus, it is necessary to ensure that the brakes are operating correctly. For example, if the brake does not open correctly, a brake pad may drag against traction sheave during elevator run, causing e.g. accelerated wear, and may further lead to degradation of the braking force. A potential hazardous situation may occur if the brake does not close properly, i.e. in case it does not start braking as intended.

Especially in new elevators correct opening of the brake may be monitored with a sensor, such as a brake switch, which changes its state when the brake opens. However, brake switches may be expensive, unreliable, and sometimes difficult to fit into the brake monitoring system.

Sometimes the brake switch doesn't notice that the brake has not opened or closed completely. It is also possible that brake malfunction develops gradually as the friction in the brake axel slowly increases over a longer period of time. This can mean that brake malfunction may continue for some time before noticed.

Consequently, there is a need for solutions detecting malfunction of hoisting machinery brakes in a reliable way.

### SUMMARY OF THE INVENTION

An object of the present invention is to introduce an elevator system and a method for elevator brake failure detecting. The invention provides solutions relating to problems associated with malfunction of elevator hoisting machinery brakes described above and hereinafter.

The elevator system for elevator brake failure detecting according to the invention is defined in independent claim 1.

Generally, the invention represents an elevator system comprising an elevator car, a hoisting machinery for driving the car in elevator shaft between landing floors, a sensor operable to obtain movement data—preferably acceleration data—of the car and at least one mechanical brake, in particular a hoisting machinery brake, for braking movement of the car and/or holding the car standstill. The elevator system further comprises at least one sensor operable to obtain movement data of the car. The elevator system is configured to detect a change in the condition of said at least one mechanical brake based on said movement data of the car obtained by at least one the sensor during normal operation.

The method for elevator brake failure detecting according to the invention is defined in claim 11.

The present disclosure introduces a solution for condition monitoring of hoisting machinery brakes. Such solution is compatible for new elevators, and it may be easily retrofitted to old elevators as well, both for OEM elevators and for third party elevators obtained under a maintenance contract.

The advantage of the solution is that it can remotely detect this kind of very critical security malfunction of an elevator before it happens. Thus, elevator safety can be increased with minimal additional costs.

### BRIEF DESCRIPTION OF THE DRAWINGS

The invention will in the following be described in greater detail by means of preferred embodiments with reference to the attached drawings, in which:

FIG. 1 shows a side view of an elevator system with a brake for braking movement of the car and/or holding the car standstill,

FIG. 2 shows elevator brake failure detecting method steps according to an embodiment,

FIG. 3 shows example graphs of start kick and acceleration peak values, and

FIGS. 4 and 5 show examples of oscillation in the acceleration of the car.

### DETAILED DESCRIPTION

In the present figures, an elevator is not shown to scale, but the figures are schematic, illustrating the basic structure and operation of preferred embodiments. In this case, the components indicated by reference numerals in the accompanying figures correspond to the components indicated by reference numerals in this description.

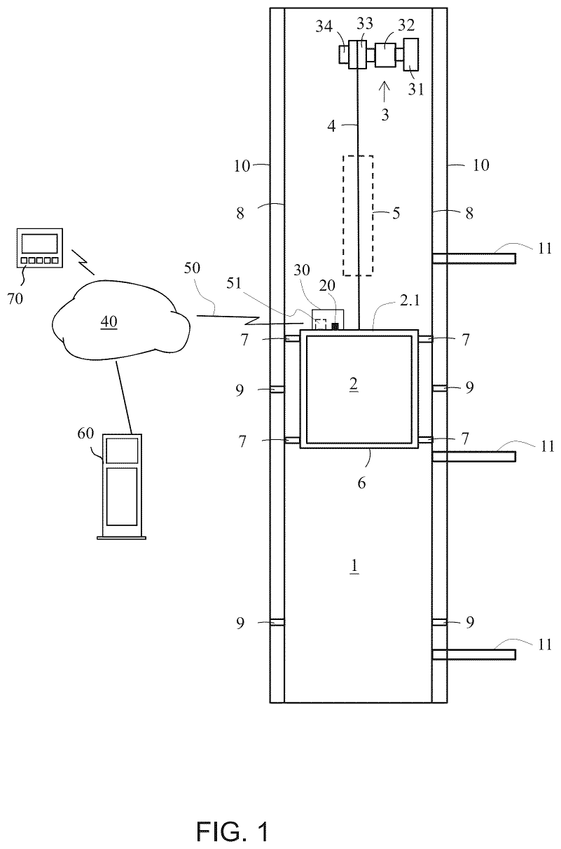

FIG. 1 shows the elevator system with a car 2, a shaft 1, a hoisting machinery 3, suspension ropes 4, and a counterweight 5. A separate or an integrated car frame 6 also called as a sling may surround the car. The hoisting machinery 3 may be positioned in the shaft 1. The hoisting machinery may comprise a drive 31, an electric motor 32, and a traction sheave 33.

The system comprises at least one mechanical brake 34 for braking movement of the car and/or holding the car standstill.

According to an embodiment illustrated in FIG. 1 the at least one mechanical brake 34 comprises a hoisting machinery brake 34 located in connection with the hoisting machinery 3.

Said at least one mechanical brake for braking movement of the car and/or holding the car standstill does not have to be in the hoisting machinery 3.

According to an embodiment the at least one mechanical brake for braking movement of the car and/or holding the car standstill comprises at least one mechanical brake located in the car 2, preferably acting on the guide rails of the car.

According to an embodiment the at least one mechanical brake 34 for braking movement of the car and/or holding the car standstill comprises at least one hoisting machinery brake 34 located in connection with the hoisting machinery 3 and at least one mechanical brake located in the car 2.

The hoisting machinery 3 may move the car upwards and downwards in the shaft. The machinery brake 34 may stop the rotation of the traction sheave 33 and thereby the movement of the elevator car 2.

In FIG. 1, the car 2 is connected by the ropes 4 via the traction sheave 33 and one or more diverting pulleys (not shown in the Figure) to the counterweight 5. The car and the counterweight are suspended by one or more ropes 4 which are guided over the traction sheave 33 for moving the car 2 vertically in the shaft 1.

In FIG. 1, the car 2 is further supported with guide members 7 at guide rails 8 extending in the vertical direction in the shaft. The guide rails may be attached with fastening brackets 9 to the side wall structures 10 in the shaft. The guide members 7 ensure the vertical movement of the car 2 when the car moves upwards and downwards in the shaft 1. The counterweight 5 may be supported in a corresponding way on guide rails that are attached to the wall structure of the shaft.

The elevator system further comprises a sensor 20 operable to obtain movement data of the car 2.

The elevator system is configured to detect a change in the condition of said at least one mechanical brake 34 based on said movement data of the car obtained by the sensor 20 during normal operation.

The term “normal operation” means elevator service, i.e. transferring elevator passengers and/or goods between landing floors with an elevator car, such that movement of the car may follow a desired motion profile.

According to an embodiment the elevator system comprises a condition-based monitoring system configured to detect a change in the condition of the at least one mechanical brake 34 for braking movement of the car and/or holding the car standstill brake based on the movement data of the car obtained by the sensor 20 during normal operation.

According to an embodiment the sensor 20 operable to obtain movement data of the car 2 is attached to the car 2. Preferably the sensor 20 is mounted to elevator car roof 2.1

According to an embodiment the elevator system comprises a processing device 30 with the acceleration sensor 20. Preferably the processing device 30 is attached to the elevator car, preferably mounted to elevator car roof 2.1. The processing device 30 is configured to collect and process data of elevator operation, in particular car movement data.

According to an embodiment the elevator system comprises an external cloud computing network 40, a wireless communication system 50 such as a data link, and a wireless transceiver 51. The processing device 30 is configured to send data of elevator operation, in particular car movement data to the external cloud computing network 40 via the wireless data link 50, e.g. a cellular network. For this purpose the device 30 comprises the wireless transceiver 51.

According to an embodiment the wireless data link 50 is configured to a communication system for transmitting messages to a predetermined receiver which may be located outside of the installation site of the elevator. The communication system may be a wireless communication system 50 such as a mobile communication system or a cellular network, for instance.

According to an embodiment the movement data of the car 2 obtained by the sensor 20 is be transmitted from the processing device 30 to a remote monitoring center 60 which monitors the operation of a plurality of elevators, for instance. The monitoring center 60 may include a server or utilize a cloud service for storing incoming messages such that maintenance personnel may utilize portable terminals 70, for instance, to check the status of the monitored elevator installations. Alternatively or in addition, the movement data may be transmitted directly to at least one terminal 70 of the maintenance personnel, for instance.

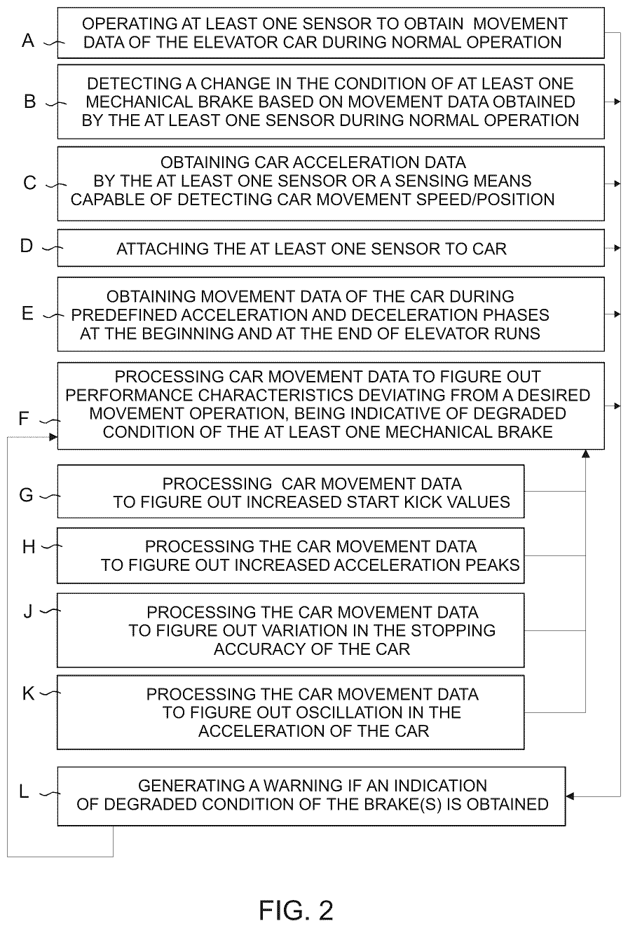

FIG. 2 illustrates an example flow diagram of a method for elevator brake failure detecting. The diagram sequentially depicts steps of an embodiment for condition monitoring of hoisting machinery brakes.

It has been found that the elevator data after the start, in other words, after the acceleration, can reveal anomalies in the braking functionality, for example the brakes do not fully open on command.

It has been found that to a significant degree the elevator brake malfunction does not happen suddenly, but the friction in a mechanical element of the elevator brake such as a brake axel or brake sleeve is slightly increased in a longer period of time—both during brake opening and closing events i.e., both when the elevator starts and stops. In addition, the failure mode must have evolved over a longer time period and thus the data after the start reveals anomalies in the braking functionality.

Changes in the car movement data (B in FIG. 2), in particular acceleration data, as obtained by the sensor 20 (A in FIG. 2), are used to detect the brake malfunction, as described in this description. According to an embodiment the car movement data is obtained during predefined acceleration and deceleration phases at the beginning and at the end of elevator runs (E in FIG. 2).

The processing device 30 forming an analytic unit obtains or collects car movement data by means of the movement data sensor 20, in particular acceleration sensor, during predefined acceleration and deceleration phases at the beginning and at the end of elevator runs, i.e. when the car 2 leaves from a departure floor 11 and when it arrives to a destination floor 11.

According to an embodiment car movement data is processed to figure out at least one of the following: start kick, acceleration peaks, stopping accuracy, and oscillations which may be periodical. In other words, movement data is processed to figure out performance characteristics deviating from a desired car movement operation and being indicative of degraded condition of the brakes (F in FIG. 2). The analysis may be carried on in an external cloud computing network 40 or e.g. in a local control unit or edge computing unit located in elevator site.

According to an embodiment, the car movement data is processed to figure out increased start kick values during the acceleration phase of the car 2 (G in FIG. 2). The start kick is a maximum peak to peak value in a filtered acceleration signal. This signal is a short period, preferably a 3 second period, around the start of the movement of the car 2. Brake problems may be found by monitoring and detecting increase of start kick value over time.

According to an embodiment, the car movement data is processed to figure out increased acceleration peaks during the later acceleration phase of the car 2 (H in FIG. 2).

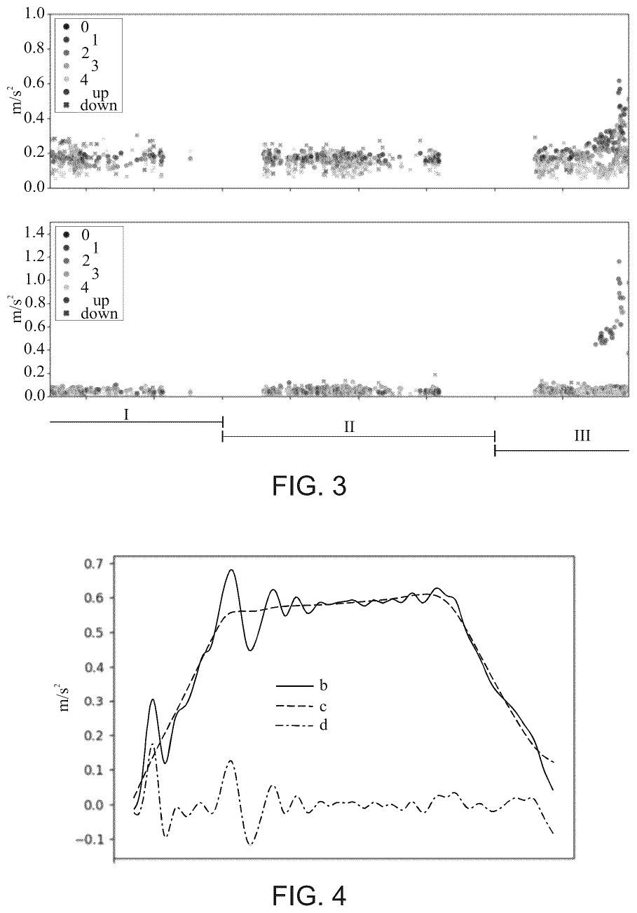

FIG. 3 shows an example of obtained start kick values during the acceleration phase of the car 2 (illustrated in the lower graph) and acceleration peak values during the later acceleration phase of the car 2 (illustrated in the upper graph) in an elevator system as a function of time.

The time period of condition monitoring of the elevator brakes is shown on the horizontal axes over three 24-hour periods, Day I, Day II and Day III. The vertical axes represent elevator car 2 acceleration m/s².

The first two 24-hour monitoring periods I and II, when the elevator is used mostly between 3 and 19-hours, the start kick values form groups of constant values below 0.1 m/s². On the third day III, the start kick values further comprise a significant group of rides with increased start kick values above 0.4 m/s² up to 1, 2 m/s², indicating degraded condition of the brake(s).

Also, the acceleration peak values form groups of constant values mostly between 0.1 m/s² and 0.3 m/s² on the first two monitoring periods I and II. On the third day III, at the same time as more and more increased start kick values are registered, the acceleration peak values further comprise a significant group of rides with increased acceleration peak values above 0.3 m/s² up to 0.6 m/s², indicating degraded condition of the brake(s).

Notably, the increased start kick values, and thus the brake jamming, do not happen in all the rides. Thus, it is also unlikely that it would happen multiple times when a maintenance person is visiting the elevator. Thus, a movement data-based condition monitoring method is found superior to visible inspection as it allows long term comparison of elevator performance and changes in the data.

According to an embodiment, the car movement data is processed to figure out variation in the stopping accuracy of the elevator car 2 when approaching a landing floor level 11 in the shaft 1 (J in FIG. 2).

According to an embodiment, the car movement data is processed to figure out oscillation in the acceleration of the car 2 (K in FIG. 2). A variable acceleration peak is calculated as the maximum distance from the filtered acceleration signal to actual acceleration signal. In other words, it describes the maximum so called ‘vibration’ of the elevator during the acceleration phase of the car 2. Brake problems may be monitored and detected as oscillations in this acceleration peak data when its values grow and diminish over periods of time possibly indicating presence of wear in a mechanical element of the elevator brake such as the brake axel or the brake sleeve.

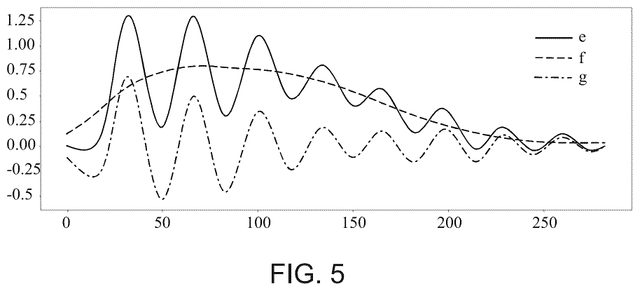

FIG. 4 shows an example of oscillation in the acceleration of the car 2. A detrended oscillation signal d is constructed from a filtered actual oscillating acceleration signal b obtained in the acceleration period of the car 2. Reference sign c illustrates as a smooth curve an RMS value of the filtered signal b. The detrended oscillation signal d represents how signals b and c compare between another.

FIG. 5 shows how a detrended oscillation signal g is constructed from a filtered actual oscillating acceleration signal e obtained in the acceleration period of the car 2, wherein the oscillation originating from the defective brakes can be identified. Reference sign f illustrates as a smooth curve an RMS value of the filtered signal e. The detrended oscillation signal g represents how signals e and f compare between another.

According to an embodiment, as an indication of degraded condition of the brake(s) is obtained, a maintenance visit to the elevator site is scheduled to check and repair the brake(s) if necessary.

Because elevator brakes are crucial for safe operation, it may be necessary to generate warnings and/or interrupt elevator service until brake check and repairment work has been carried out. According to an embodiment a warning is generated if an indication of degraded condition of the brake(s) (brake failure) is obtained (L in FIG. 2), preferable to be communicated to persons responsible for the condition of the elevator such as maintenance personnel.

According to an embodiment the solutions described above can be applied also to elevators without direct acceleration measurements since the acceleration, and preferably signals calculated from it, can be calculated from measured speed/position.

According to an embodiment, the elevator system is configured: to determine an undesired elevator car movement component, such as undesired variation in stopping accuracy and/or a start kick and/or an oscillation component and/or a peak value, from movement data obtained during normal operation; and to detect a change in the condition of said at least one mechanical brake based on said movement component.

According to an embodiment, said data processing may comprise applying statistical methods and/or artificial intelligence.

Thus, the elevator system and the elevator brake failure detecting method may be implemented in an elevator system comprising a sensing means capable of detecting car movement speed/position.

The use of the invention is not limited to the embodiments disclosed in the figures. The invention can be used in any type of elevator e.g. an elevator comprising a machine room or lacking a machine room, an elevator comprising a counterweight or lacking a counterweight. The counterweight could be positioned on either side wall or on both side walls or on the back wall of the elevator shaft. The drive, the motor, the traction sheave, and the machinery brake could be positioned in a machine room or somewhere in the elevator shaft. The elevator car guide rails could be positioned on opposite side walls of the shaft or on a back wall of the shaft.

It will be obvious to a person skilled in the art that, as the technology advances, the inventive concept can be implemented in various ways. The invention and its embodiments are not limited to the examples described above but may vary within the scope of the claims.

1. An elevator system for elevator brake failure detecting comprises:
an elevator comprising a car; a hoisting machinery for driving the car in an elevator shaft between landing floors; and at least one mechanical brake for braking movement of the car and/or holding the car standstill; and the elevator system further comprises at least one sensor operable to obtain movement data of the car;
wherein
the elevator system is configured to detect a change in the condition of said at least one mechanical brake based on said movement data obtained by the at least one sensor during normal operation.

2. The elevator system according to claim 1, wherein the movement data obtained by the at least one sensor comprises car acceleration data.

3. The elevator system according to claim 1, wherein the at least one sensor comprises an acceleration sensor or a sensing means capable of detecting car movement speed/position.

4. The elevator system according to claim 1, wherein the at least one sensor is attached to the car, preferably to the car roof.

5. The elevator system according to claim 1, wherein the at least one mechanical brake comprises at least one hoisting machinery brake comprised by the hoisting machinery and/or the at least one mechanical brake is located in the car.

6. The elevator system according to claim 1, comprising a processing device with the at least one sensor, the processing device is configured to collect and process movement data of the car obtained by the at least one sensor.

7. The elevator system according to claim 1, wherein the system is configured:
to determine an undesired elevator car movement component, such as undesired variation in stopping accuracy and/or a start kick and/or an oscillation component and/or a peak value, from movement data obtained during normal operation; and
to detect a change in the condition of said at least one mechanical brake based on said movement component.

8. The elevator system according to claim 6, comprising an external cloud computing network, a wireless data link and a wireless transceiver for communicating the movement data of the car obtained by the at least one sensor from the processing device to the external cloud computing network.

9. The elevator system according to claim 1, wherein the hoisting machinery comprises a motor, a traction sheave and at least one hoisting machinery brake.

10. The elevator system according to claim 1, wherein the elevator system comprises:
one or more suspension ropes; and a counterweight;
the car and the counterweight being suspended by said one or more ropes which are guided over a traction sheave for moving the car vertically in the elevator shaft.

11. A method for elevator brake failure detecting in an elevator system, comprising: an elevator comprising a car; a hoisting machinery for driving the car in an elevator shaft between landing floors; and at least one mechanical brake for braking movement of the car and/or holding the car standstill; wherein the method comprises operating at least one sensor comprised by the elevator system to obtain movement data of the car during normal operation;
wherein the method comprises
detecting a change in the condition of said at least one mechanical brake based on said movement data obtained by the at least one sensor during normal operation.

12. The method according to claim 11, wherein the method comprises obtaining car acceleration data by the at least one sensor, preferably an acceleration sensor or a sensing means capable of detecting car movement speed/position.

13. The method according to claim 11, wherein the method comprises attaching the at least one sensor to the car, preferably to the car roof.

14. The method according to claim 11, wherein the at least one mechanical brake comprises at least one hoisting machinery brake comprised by the hoisting machinery and/or the at least one mechanical brake is located in the car.

15. The method according to claim 11, wherein the method comprises obtaining movement data of the car during predefined acceleration and deceleration phases at the beginning and at the end of elevator runs.

16. The method according to claim 11, wherein the method comprises processing car movement data to figure out performance characteristics deviating from a desired car movement operation and being indicative of degraded condition of the at least one mechanical brake.

17. The method according to claim 16, wherein the method comprises processing the car movement data to figure out increased start kick values during the acceleration phase of the car.

18. The method according to claim 16, wherein the method comprises processing the car movement data to figure out increased acceleration peaks during the later acceleration phase of the car.

19. The method according to claim 16, wherein the method comprises processing the car movement data to figure out variation in the stopping accuracy of the elevator car when approaching a landing floor level in the shaft.

20. The method according to claim 16, wherein the method comprises processing the car movement data to figure out oscillation in the acceleration of the car.

21. The method according to claim 11, wherein the method comprises generating a warning if an indication of degraded condition of the brake is obtained.
